(19) United States
(12) Patent Application Publication
(10) Pub. No.: US 2005/0002408 A1
(43) Pub. Date: Jan. 6, 2005

(54) Home appliance network system and method for operating the same

(75) Inventor: Sang Kyun Lee, Kyungki-do (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/869,880

(22) Filed: Jun. 18, 2004

(30) Foreign Application Priority Data
Jun. 20, 2003 (KR) 2003-40272

(51) Int. Cl. H04L 12/28

(52) U.S. Cl. 370/401; 379/399.01

(57) ABSTRACT

A home appliance network system and a method for operating the same, wherein a network master can not only automatically generate a unique house address of a corresponding home, but also sense a network collision of the corresponding home with a neighboring home to maintain house address uniqueness. The network master manages/controls one or more home appliances connected to a network of the corresponding home and determines whether the generated house address collides with that of the neighboring home. If the generated house address is determined to collide with that of the neighboring home, the network master automatically changes the house address to a new one to maintain house address uniqueness. As a result, the network master can prevent a network interference/collision with the neighboring home, thereby increasing security and stability of the home appliance network system at low cost.

### BACKGROUND OF THE INVENTION

1. Field of the Invention

The present invention relates to a home appliance network system wherein a plurality of home appliances are connected over a network in such a manner that they can control one another and a method for operating the same, and more particularly to a network master which is installed in each home to assign a unique house address to the corresponding home so as to distinguish a network thereof from those of neighboring homes.

The network master is adapted to sense a collision of the corresponding home's house address with any one of the neighboring homes' house addresses and, upon initial network construction or additional home appliance connection, automatically generate a new house address, update the existing house address with the new one and register the updated house address, even without a user's manual input. Therefore, the home appliance network system and the method for operating the same according to the present invention have the effect of increasing convenience of the user and strengthening stability and security of the home appliance control.

2. Description of the Related Art

In general, a home appliance network system means a system in which a plurality of home appliances, including a personal computer (PC), are integrated in one network constructed in a home, so they can transmit and receive data to/from one another over the network.

Recently, an in-home network has been basically constructed and an integrated control technique and data communication technique based on the network and the associated control software have been developed together, resulting in increases in the concern and demand for the home appliance network system.

Such home appliance network systems can be variously classified according to the types of networks, which are the bases thereof. These networks may be, for example, a telephone line network using telephone lines, which are installed in most homes, a local area network (LAN), a wireless network and a power line network. It should be noted herein that the present invention is not limited to such examples.

In this specification, either a conventional or present embodiment will be described for illustrative purposes to be a network system wherein home appliances are connected over a power line.

The technical field of the invention will hereinafter be described with reference to FIG. 1, which shows the configuration of a conventional home appliance network system.

As shown in FIG. 1, a plurality of home appliances A1-A3 are connected to a network of a home A, and a plurality of home appliances B1-B3 are connected to a network of a home B. A network master 10A functions as a home server to control and monitor the home appliances A1-A3, and a network master 10B functions as a home server to control and monitor the home appliances B1-B3.

The network masters 10A and 10B each can not only centrally control the corresponding home appliances A1-A3 or B1-B3, but also access an external Internet network. As a result, the network masters 10A and 10B can each relay a remote command that is sent from a remote control user over the Internet network.

In particular, where the home appliance network system uses a power line, it is economic in that the power line is typically pre-installed in a building, resulting in a reduction in construction cost of the system.

However, the power line is typically constructed, not individually according to homes/offices in the building, but commonly in all of them. In this connection, where the power line is used in common in a plurality of homes or offices for home appliance networking, it is not easy to distinguish respective network management areas of the homes or offices from one another, causing inter-network interference.

In other words, in the case where the power line constructed commonly in the building is shared by a plurality of homes in the building for home appliance networking, it is impossible to divide the power line according to the homes, so a control command signal inputted by a control user of any one of the homes may be sent to a home appliance in a different one of the homes, resulting in a concern that an error could occur during data transmission and reception.

In FIG. 1, the homes A and B are indicated by dotted lines, respectively. Since the homes A and B have their networks interconnected via one power line, a blocking filter BF is installed between the networks of the homes A and B to prevent a data transmission/reception error from occurring therebetween.

If a manager of any one, for example, A, of the homes connects a new home appliance to the network of the home A, the new home appliance broadcasts a connection message notifying that it has been connected to the network.

Upon receiving the connection message, the network master 10A registers the network connection of the new home appliance by assigning a unique house address, pre-assigned to the home A, to that home appliance.

In this case, however, the connection of physical equipment, such as the blocking filter BF, is required for every home, increasing the construction cost. Further, provided that no inter-network isolation is made due to a fault or malfunction of the blocking filter BF, the new home appliance may be connected to the network of the neighboring home B and the network registration thereof may thus be imperfectly carried out.

Alternatively, for isolation between the networks of the adjacent homes A and B, the network master 10A may request the manager to manually set a house address, upon receiving the connection message broadcast by the new home appliance.

That is, the network master 10A requests the manager to permit the connection of the new home appliance, receives a password or a serial number of the home appliance manually inputted from the manager and registers the network connection of the home appliance.

In this case, however, the manager has the inconvenience of having to manually set a serial number or other information upon initial network construction or whenever an additional home appliance is connected to the corresponding network.

Moreover, it is impossible to prevent a network collision resulting from duplication of a manually inputted house address with a house address of a neighboring home without using the blocking filter BF. This degrades security and stability of the home appliance network system.

### SUMMARY OF THE INVENTION

Therefore, the present invention has been made in view of the above problems, and it is an object of the present invention to provide a home appliance network system and a method for operating the same, wherein a network master can sense duplication of a house address of a corresponding home with that of a neighboring home in advance, thereby making it possible to prevent a network collision between homes sharing the same power line.

It is another object of the present invention to provide a home appliance network system and a method for operating the same, wherein a network master can assign a unique house address with no collision with those of neighboring homes to a corresponding home, and sense the connection of a new or additional home appliance to a network of the corresponding home and automatically register the home appliance in the network, thereby increasing convenience of use.

In accordance with an aspect of the present invention, the above and other objects can be accomplished by the provision of a home appliance network system comprising: a plurality of home appliances connected to a network for transmitting and receiving data over the network, the network being constructed for home appliance networking in a corresponding home; and a network master for generating and assigning a unique house address to the corresponding home, determining whether the assigned house address collides with any one of house addresses of neighboring homes, and automatically changing the assigned house address upon determining that it collides with any one of the house addresses of the neighboring homes.

In accordance with another aspect of the present invention, there is provided a method for operating a home appliance network system using a network master which manages/controls a network constructed in a corresponding home, the method comprising the steps of: a) generating a house address to distinguish the network of the corresponding home from those of neighboring homes; b) determining whether the generated house address collides with any one of house addresses of the neighboring homes; and c) assigning a unique house address with no collision with any of the house addresses of the neighboring homes to a plurality of home appliances connected to the network according to a result of the determination. In this method, the network master is operated to generate and assign a unique house address upon initial network construction.

In accordance with yet another aspect of the present invention, there is provided a method for operating a home appliance network system using a network master which manages/controls a network constructed in a corresponding home, the method comprising the steps of: a) receiving arbitrary data over the network; b) searching a database for information regarding a home appliance transmitting the data to determine whether the appliance information is present in the database; c) determining the transmitting home appliance to be a home appliance newly connected to the network or a home appliance of a neighboring home, upon determining that the appliance information is not present in the database; and d), if the transmitting home appliance is determined to be the home appliance of the neighboring home, determining that a house address of the corresponding home collides with that of the neighboring home and re-generating a new unique house address. In this method, the network master is in normal operation and determines on the basis of data inputted over the network whether to communicate with a home appliance transmitting the data.

A home appliance network system is a system that controls the operations of one or more home appliances over a network constructed in a home. A network master is connected to the network to perform an active control/home server function. The home appliances each are passively operated in response to a control signal applied from the network master or a control command manually inputted thereto.

The network may be, but not limited to, a telephone line network, a wired local area network (LAN), a wireless LAN, a power line network or etc. It will also be understood that the types of the home appliances are not limited to those shown in the drawings.

Each of the home appliances includes a network modem for transmitting and receiving data over the network, and a microcomputer for performing an operation corresponding to a manually inputted control command or a control signal inputted over the network.

The network master senses the flow of signals being transmitted and received over the network and monitors the states of the home appliances connected to the network.

Further, the network master performs network registration of a home appliance newly or additionally connected to the network, generates a unique house address for network isolation with a neighboring home and assigns it to the connected home appliance.

At this time, the network master prevents a network collision with the neighboring home by determining whether the house address is identical to that of the neighboring home. Therefore, it is possible to strengthen security of the home appliance network system and increase stability thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of a conventional home appliance network system;

FIG. 2 is a view showing the configuration of a home appliance network system according to the present invention;

FIG. 3 is a detailed block diagram of a network master in the home appliance network system according to the present invention;

FIG. 4 is a flow chart illustrating an initial operation of the home appliance network system according to the present invention;

FIG. 5 is a flow chart illustrating a normal operation of the home appliance network system according to the present invention; and

FIG. 6 is a flow chart illustrating a house address re-setting operation of the home appliance network system according to the present invention.

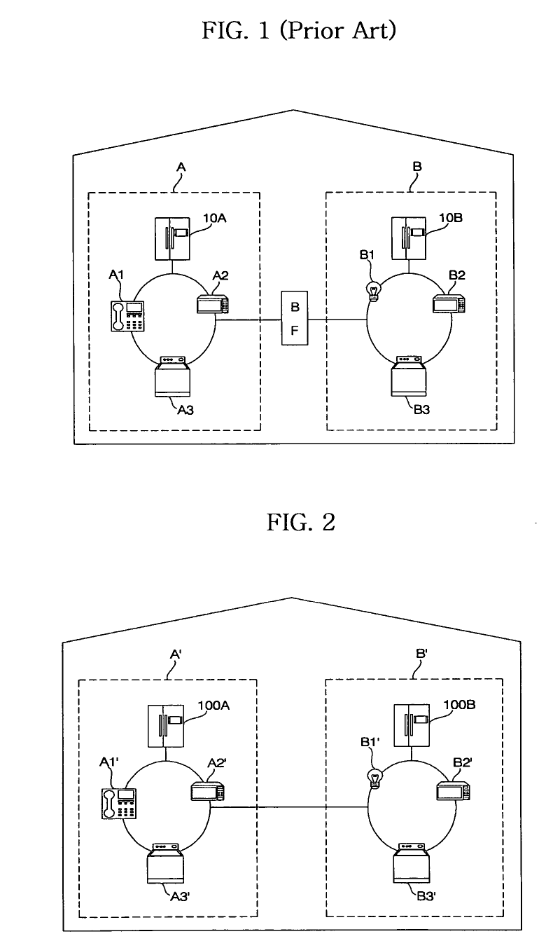

### DESCRIPTION OF THE PREFERRED EMBODIMENTS

Now, preferred embodiments of a home appliance network system and a method for operating the same according to the present invention will be described in detail with reference to the annexed drawings.

Although various embodiments of the home appliance network system according to the present invention may be realized, only the most preferred one thereof will hereinafter be described. Here, the basic structure of the home appliance network system is similar to that of the above-mentioned conventional system and a detailed description thereof will thus be omitted.

FIG. 2 shows the configuration of the home appliance network system according to the present invention.

As shown in FIG. 2, a plurality of home appliances A1′-A3′ are connected to a network of a home A′, and a network master 100A is also connected to the network to control and monitor the network and the home appliances A1′-A3′ connected thereto.

A plurality of home appliances B1′-B3′ and a network master 100B are similarly connected to a network of a home B′. The homes A′ and B′ are neighbors sharing the same power line.

Each of the network masters 100A and 100B is a home appliance that is connected to the corresponding network to function to control/manage transmission and reception of signals among the corresponding home appliances A1′-A3′ or B1′-B3′. In a preferred embodiment of the present invention, each network master is, but not limited to, an Internet refrigerator that is implemented with a home server function of monitoring the states of the home appliances and controlling the operations thereof, as well as a cold storage function.

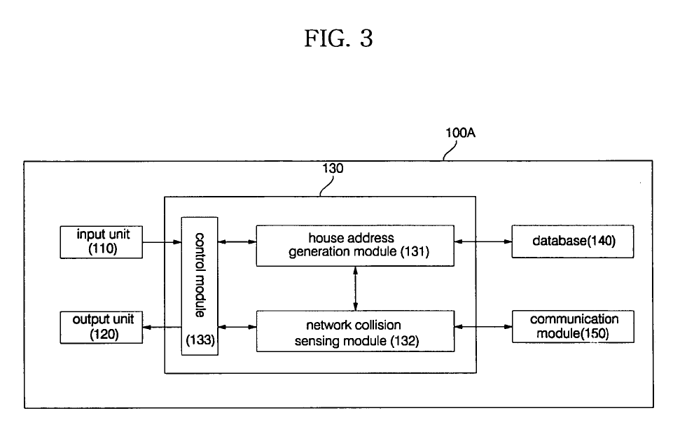

Each of the network masters 100A and 100B, which is connected to the corresponding network and adapted to transmit and receive data to/from the corresponding home appliances to actively control them, is constructed as shown in FIG. 3.

The network master, for example, 10A, includes an input unit 110 for receiving a user's input, and an output unit 120 for outputting control results and state monitoring results of the home appliances A1′-A3 connected to the network of the home A′.

Preferably, the input unit 110 and the output unit 120 can be made integrally with each other in the form of a touch panel, thereby increasing space efficiency of the network master 100A and convenience of the user.

The network master 100A further includes a microcomputer 130 for generating a unique house address of the corresponding home such that it is not duplicated by a unique house address of any neighboring home sharing the same power line therewith and there is thus no network collision between the corresponding home and the neighboring home, determining whether the house address of the corresponding home is duplicated by that of the neighboring home, and automatically changing the house address of the corresponding home if it is duplicated by the house address of the neighboring home.

The house address is uniquely assigned to the corresponding home to distinguish a network thereof from that of the neighboring home. The microcomputer 130 may generate the house address automatically or based on an input through the input unit 110.

The network master 100A further includes a database 140 for storing information regarding a plurality of home appliances to be controlled, which contains serial numbers of the home appliances. As a result, the microcomputer 130 can perform a home server function and network management function on the basis of the appliance information stored in the database 140.

The network master 100A further includes a communication module 150 for transmitting and receiving data to/from the plurality of home appliances over the corresponding network. The communication module can be equipped with different modems according to different types of the corresponding network.

The network may be, for example, a wireless LAN using a radio frequency of 2.4 GHz, a network using a low-voltage (110/220V) power line that carries data in a high-frequency signal of several hundred kHz to several tens of MHz, or etc. In the present embodiment, since the network uses the power line, it is preferable that the communication module 150 is a power line modem.

The network master 100 of the present invention may also be applied to the wireless network in that a control signal generated in any one home may be propagated to a neighboring home, resulting in a network collision, similarly to in the power line network.

The microcomputer 130 includes a house address generation module 131 for generating the unique house address of the corresponding home where the network master 100A is installed, on the basis of a serial number of the network master 10A, a telephone number of the corresponding home or an arbitrary code set by the user, and a network collision sensing module 132 for sensing a network collision of the corresponding home with a neighboring home according to a response signal received after broadcasting the generated house address to the corresponding network.

The microcomputer 130 further includes a control module 133 for, if a collision of the generated house address with that of a neighboring home is sensed, controlling the house address generation module 131 to generate a new house address and, if no collision of the generated house address is sensed, setting that house address in the plurality of home appliances connected to the corresponding network.

The control module 133 is also adapted to transmit and receive only data containing the same house address as a registered one to define a network area, so as to exclude data incoming from a neighboring home over the corresponding network.

With this configuration, the microcomputer 130 controls the operations of the home appliances A1′-A3′ connected to the corresponding network, monitors the states thereof and manages network connection registrations thereof, at the same time as controlling an internal data flow of the network master 100A.

At this time, if the network collision sensing module 132 senses a collision of the house address generated by the house address generation module 131 with that of a neighboring home, then it feeds the sensed result back to the house address generation module 131 to request it to re-generate a new house address.

As a result, the house address generation module 131 can verify whether a neighboring home with a house address identical to the generated house address exists.

In other words, the network master 100A can secure stability of the home appliance control by not only automatically generating and assigning a house address upon initial construction of the corresponding network, but also maintaining uniqueness of the house address with respect to home appliances newly or additionally connected to the network after the construction thereof is completed.

Therefore, the network master 100 of the present invention can prevent network interference with a neighboring home or building without using physical equipment such as a conventional blocking filter.

Although a network area distinguished with a house address has been disclosed to be a home in the present embodiment, the present invention is not limited thereto.

On the other hand, in the case where a plurality of network masters are present in one home, home appliances connected to a network of the home may be grouped according to functions or installation zones thereof so that a house address generated and registered by each of the network masters can be recognized as a group code.

It is also preferable that the house address generated by the network master 100A includes, but not limited to, a serial number of the network master 100A or a telephone number of the home where the corresponding network is constructed.

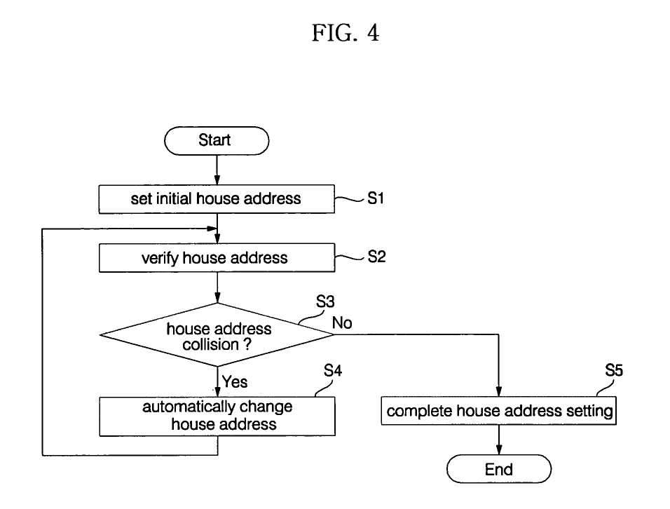

Next, the operation of the home appliance network system according to the present invention will be described with reference to FIGS. 4 to 6, which are flow charts illustrating a network collision sensing algorithm which is applied to the network master of the present invention.

FIG. 4 is a flow chart illustrating an operation of the network master upon initial construction of the home appliance network system according to the present invention.

First, the network master, initially connected to the corresponding network, generates a house address (S1).

For verification of the generated house address, the network master broadcasts that house address to the network and determines whether there is a home appliance responding to the broadcasting (S2).

That is, a response signal is sent from a neighboring network in the initial construction state of the corresponding network, which means that the same house address as the generated house address is used in the neighboring network. As a result, the network master can sense a collision of the generated house address with that of the neighboring network (S3).

The network master automatically changes the generated house address if it collides (S4) and completes the initial house address setting if it does not collide (S5).

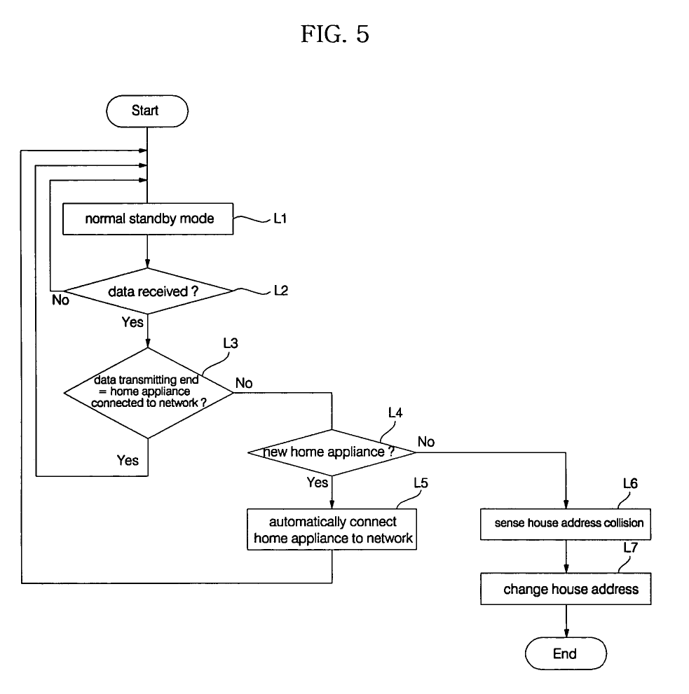

FIG. 5 is a flow chart illustrating an operation of the network master under the condition that a plurality of home appliances are connected to the corresponding network after the initial network construction is completed.

The network master monitors the corresponding network and the plurality of home appliances connected thereto while maintaining a normal standby mode (L1).

If the network master receives arbitrary data (L2), then it determines whether a transmitting end of the data is any one of the home appliances connected to the network (L3).

That is, the network master determines whether the data has been sent from any one home appliance connected to the corresponding network or from a neighboring home, by reading a house address and appliance information contained in the data and comparing it with information stored in the database thereof.

If the data has not been sent from any home appliance connected to the network, the network master determines whether the data has been sent from a new home appliance or a neighboring home due to a house address collision (L4).

Upon determining that the data has been sent from a new home appliance, the network master approves the connection of the new home appliance to the network and registers it in the database (L5). However, if the data has not been sent from a new home appliance, the network master determines that the data has been sent from a neighboring home due to a house address collision (L6).

Thus, the network master automatically changes the existing house address whose uniqueness was lost to a new one (L7).

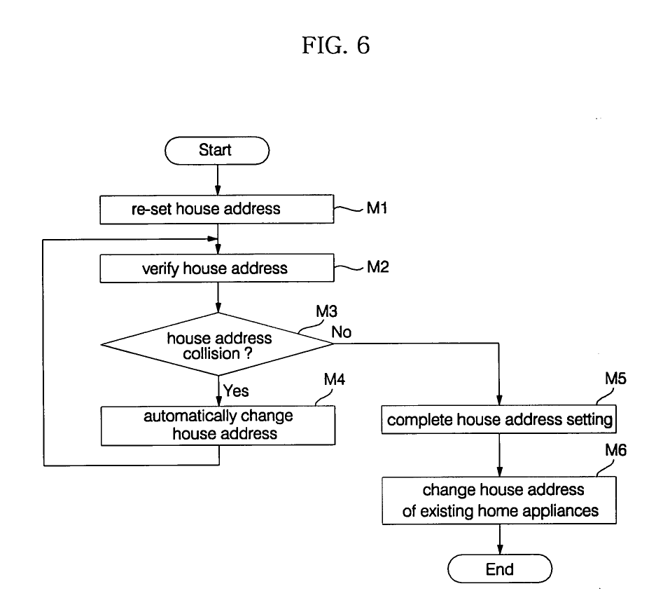

The network master performs the house address re-setting operation as shown in a flow chart of FIG. 6. First, the network master re-sets a house address different from the existing one (M1).

In order to verify the re-set house address, the network master broadcasts that house address to the network and determines whether there is a home appliance responding to the broadcasting (M2).

Since the home appliances connected to the network always respond to only the same house address, the presence of a response to the broadcast house address means that the broadcast house address has already been used in a different network.

The network master determines whether the broadcast house address collides with a house address in a different network (M3). If the broadcast house address is determined to collide with a house address in a different network, the network master automatically changes it and repeats the house address verification (M4). However, if the broadcast house address does not collide, the network master completes the house address re-setting operation (M5).

The network master further inputs the re-set house address to the home appliances with the existing house address connected to the network such that all the home appliances have the new house address (M6).

As apparent from the above description, the present invention provides a home appliance network system and a method for operating the same, wherein a network master can not only automatically generate a house address of a corresponding home, but also sense a network collision of the corresponding home with a neighboring home. The network master automatically sets and registers a unique house address such that it is always held by the corresponding home. Therefore, it is not necessary to use a high-price blocking filter, which leads to a reduction in construction cost of the system.

Further, in order to prevent a network interference/collision with a neighboring home, the network master automatically manages a house address with no need to manually set it. Therefore, security of the home appliance network system can be strengthened and stability thereof can be increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Application No. 10-2003-0040272, filed on Jun. 20, 2003, the contents of which are herein expressly incorporated by reference in its entirety.

1. A home appliance network system comprising:
a plurality of home appliances connected to a network for transmitting and receiving data over the network, said network being constructed for home appliance networking in a corresponding home; and
a network master for generating and assigning a unique house address to the corresponding home, determining whether the assigned house address collides with any one of house addresses of neighboring homes, and automatically changing the assigned house address upon determining that it collides with any one of the house addresses of the neighboring homes.

2. The home appliance network system as set forth in claim 1, wherein said network master includes:
a communication module for transmitting and receiving data to/from said home appliances over said network;
a microcomputer for, through said communication module, monitoring states of said home appliances and controlling operations thereof, and generating and assigning said unique house address to the corresponding home such that it does not collide with any of the house addresses of the neighboring homes over said network; and
a database for storing information regarding said plurality of home appliances to be controlled, said appliance information containing serial numbers of said home appliances.

3. The home appliance network system as set forth in claim 2, wherein said network master further includes:
an input unit for receiving a user's control command inputted thereto; and
an output unit for outputting state monitoring results and operation control results of said home appliances connected to said network.

4. The home appliance network system as set forth in claim 2, wherein said communication module is a power line communication module, said power line communication module transmitting and receiving data over a power line constructed in a building including the corresponding home and the neighboring homes.

5. The home appliance network system as set forth in claim 2, wherein said communication module is a radio frequency (RF) communication module, said RF communication module transmitting and receiving RF data.

6. The home appliance network system as set forth in claim 2, wherein said microcomputer includes:
a house address generation module for generating said unique house address on the basis of a serial number of said network master, a telephone number of the corresponding home where said network master is installed, or an arbitrary code set by a user; and
a network collision sensing module for sensing a network collision of the corresponding home with any one of the neighboring homes according to a response signal received after broadcasting said unique house address generated by said house address generation module to said network.

7. The home appliance network system as set forth in claim 6, wherein said microcomputer further includes a control module for, if a collision of the generated house address with any one of the house addresses of the neighboring homes is sensed, controlling said house address generation module to generate a new house address and, if no collision of the generated house address is sensed, setting it in said plurality of home appliances connected to said network.

8. A method for operating a home appliance network system using a network master which manages/controls a network constructed in a corresponding home, the method comprising the steps of:
a) generating a house address to distinguish the network of the corresponding home from those of neighboring homes;
b) determining whether the generated house address collides with any one of house addresses of the neighboring homes; and
c) assigning a unique house address with no collision with any of the house addresses of the neighboring homes to a plurality of home appliances connected to said network according to a result of the determination.

9. The method as set forth in claim 8, wherein said step b) includes the steps of:
b-1) broadcasting said generated house address to said network;
b-2) waiting for a response signal to the broadcasting to be received; and
b-3) determining whether said generated house address collides with any one of the house addresses of the neighboring homes, if said response signal is received.

10. The method as set forth in claim 9, wherein said step b-3) includes the step of returning to said step a) to generate a new house address, upon determining that said generated house address collides with any one of the house addresses of the neighboring homes.

11. A method for operating a home appliance network system using a network master which manages/controls a network constructed in a corresponding home, the method comprising the steps of:
a) receiving arbitrary data over said network;
b) searching a database for information regarding a home appliance transmitting said data to determine whether the appliance information is present in the database;
c) determining said transmitting home appliance to be a home appliance newly connected to said network or a home appliance of a neighboring home, upon determining that said appliance information is not present in said database; and
d), if said transmitting home appliance is determined to be the home appliance of the neighboring home, determining that a house address of the corresponding home collides with that of the neighboring home and re-generating a new unique house address.

12. The method as set forth in claim 11, wherein said step b) includes the steps of:
b-1) reading a house address and a home appliance serial number contained in said data to recognize said information regarding said transmitting home appliance; and
b-2) determining whether the same information as said appliance information has been registered and stored in said database.

13. The method as set forth in claim 11, wherein said step c) includes the steps of:
c-1), if said appliance information is present in said database, determining said transmitting home appliance to be an existing home appliance connected to said network and returning to said step a) and, if said appliance information is not present in said database, determining said transmitting home appliance to be the home appliance newly connected to said network; and
c-2), if said transmitting home appliance is determined to be the home appliance newly connected to said network, acquiring information regarding the newly connected home appliance, registering and storing the acquired information in said database and assigning said house address of the corresponding home to the newly connected home appliance and, if said transmitting home appliance is determined not to be the home appliance newly connected to said network, determining said transmitting home appliance to be the home appliance of the neighboring home.

14. The method as set forth in claim 11, wherein said step d) includes the step of assigning the re-generated unique house address to a plurality of home appliances connected to said network if it does not collide with the house address of the neighboring home.
